(19) United States
(12) Patent Application Publication
(10) Pub. No.: US 2023/0326237 A1
(43) Pub. Date: Oct. 12, 2023

(54) METHOD, DEVICE, ELECTRONIC DEVICE AND NON-TRANSITORY STORAGE MEDIUM FOR FINGERPRINT COMPARISON

(71) Applicant: Egis Technology Inc., Hsinchu City (TW)

(72) Inventors: YUAN-LIN CHIANG, Hsinchu City (TW); YU-CHUN CHENG, Hsinchu City (TW)

(21) Appl. No.: 18/098,394

(22) Filed: Jan. 18, 2023

Related U.S. Application Data
(60) Provisional application No. 63/327,805, filed on Apr. 6, 2022.

(30) Foreign Application Priority Data
Nov. 16, 2022 (CN) 202211436806.6

(51) Int. Cl. G06V 40/12; G06V 10/75

(52) U.S. Cl. CPC G06V 40/1376; G06V 10/7515

(57) ABSTRACT

A method for fingerprint comparison according to an embodiment includes acquiring a fingerprint image to be compared, performing a first-stage fingerprint comparison on the fingerprint image to be compared and an enrolled fingerprint image, determining, according to a result of the first-stage fingerprint comparison, whether to perform a second-stage fingerprint comparison on the fingerprint image to be compared and the enrolled fingerprint image, and determining, according to the result of the first-stage fingerprint comparison or a result of the second-stage fingerprint comparison, whether the comparison between the fingerprint image to be compared and the enrolled fingerprint image is successful. With the method, the fingerprint comparison speed can be improved.

### CROSS-REFERENCE TO RELATED APPLICATION AND CLAIM OF PRIORITY

This application claims the benefit under 35 USC § 119 of U.S. Patent Application No. 63/327,805 filed on Apr. 6, 2022, and Chinese Patent Application No. 202211436806.6, filed on Nov. 16, 2022, in the China Intellectual Property Office, the entire disclosure of which is incorporated herein by reference for all purposes.

### BACKGROUND

### 1. Technical Field

The present disclosure generally relates to the technical field of fingerprint verification. More particularly, the present disclosure relates to a method, a device, an electronic device and a non-transitory storage medium for fingerprint comparison.

### 2. Background Art

Currently, fingerprint verification with a fingerprint sensor generally includes two application scenes with large differences: one is to use a large fingerprint sensor for fingerprint comparison with a large data volume; and the other is to use a small fingerprint sensor for fingerprint comparison with a small data volume. Compared with the large fingerprint sensor, the small fingerprint sensor has lower cost.

With the continuous expansion of the application range of fingerprint verification, the application requirements of fingerprint comparison with low cost and large data volume, such as low-cost access control systems, have emerged. In order to meet the requirement of low cost, a small fingerprint sensor may be used for collecting fingerprint images, but when the fingerprint image collected by the small fingerprint sensor is used for fingerprint comparison with a large data volume, a long comparison time is involved. For example, more than ten seconds may be consumed when the fingerprint image collected by the small fingerprint sensor is used for data comparison of hundreds of fingerprints. Obviously, it is unacceptable for a user to wait more than ten seconds for a result of fingerprint verification each time.

In view of the above, there is an urgent need for a fingerprint comparison solution which can increase the speed of fingerprint comparison to meet the application requirements of fingerprint comparison with low cost and large data volume.

### SUMMARY

To address at least one or more of the above technical problems, the present disclosure proposes, in various aspects, a solution for fingerprint comparison.

In a first aspect, the present disclosure provides a method for fingerprint comparison, comprising: acquiring a fingerprint image to be compared; performing a first-stage fingerprint comparison on the fingerprint image to be compared and an enrolled fingerprint image; determining, according to a result of the first-stage fingerprint comparison, whether to perform a second-stage fingerprint comparison on the fingerprint image to be compared and the enrolled fingerprint image; and determine, according to the result of the first-stage fingerprint comparison or a result of the second-stage fingerprint comparison, whether the comparison between the fingerprint image to be compared and the enrolled fingerprint image is successful.

In some embodiments, the first-stage fingerprint comparison includes a rough alignment and/or a rough matching; and the second-stage fingerprint comparison includes at least one of a precise alignment, a rough matching and a precise matching.

In other embodiments, the first-stage fingerprint comparison includes a rough alignment; and the second-stage fingerprint comparison includes a precise alignment.

In still other embodiments, the first-stage fingerprint comparison further includes a rough matching, and performing the first-stage fingerprint comparison further includes: performing the rough matching on the enrolled fingerprint image and the fingerprint image to be compared which have been subjected to the precise alignment, where the rough matching includes performing a feature matching on one part of feature point pairs in an overlap region between the enrolled fingerprint image and the fingerprint image to be compared, and the feature point pair includes a feature point on the fingerprint image to be compared and a corresponding feature point on the enrolled fingerprint image in the overlap region; the second-stage fingerprint comparison further includes a precise matching, and determining whether to perform the second-stage fingerprint comparison further includes: determining, according to a result of the rough matching, whether to perform the precise matching on the enrolled fingerprint image and the fingerprint image to be compared, where the precise matching includes performing a feature matching on the other part of feature point pairs in the overlap region; and determining whether the comparison is successful includes: determining, according to a result of the precise matching, whether the comparison between the fingerprint image to be compared and the enrolled fingerprint image is successful.

In some embodiments, a plurality of enrolled fingerprint images are provided, and the method further comprises: acquiring a next enrolled fingerprint image, until the comparison is successful or all enrolled fingerprint images fail to pass the comparison, in response to any one of: a result of a current rough alignment failing to meet a first preset condition; a result of a current rough matching failing to meet a second preset condition; and a result of a current precise matching failing to meet a third preset condition.

In other embodiments, a plurality of enrolled fingerprint images are provided, and the method further comprises: performing a rough alignment on the fingerprint image to be compared and the plurality of enrolled fingerprint images, respectively; and performing a first screening on the plurality of enrolled fingerprint images according to a result of each rough alignment to obtain a first screening result, where the first screening result includes enrolled fingerprint images of which the result of the rough alignment meets a first preset condition.

In still other embodiments, the method further comprises: performing a precise alignment and a rough matching on each enrolled fingerprint image in the first screening result and the fingerprint image to be compared; performing, according to a result of the rough matching of each enrolled fingerprint image in the first screening result, a second screening on the first screening result to obtain a second screening result, where the second screening result includes enrolled fingerprint images of which the result of the rough matching meets a second preset condition; performing a precise matching on the other part of feature point pairs corresponding to each enrolled fingerprint image in the second screening result; and determining, according to a result of each precise matching, whether the enrolled fingerprint image in the second screening result is successfully compared with the fingerprint image to be compared.

In some embodiments, the method further comprises: performing a precise alignment and a rough matching on any enrolled fingerprint image in the first screening result and the fingerprint image to be compared; or ranking, according to a comparison result of results of rough alignments in the first screening result, the enrolled fingerprint images in the first screening result, and sequentially performing a precise alignment and a rough matching on the enrolled fingerprint images in the first screening result.

In other embodiments, the method further comprises: acquiring a next enrolled fingerprint image in the first screening result, until the comparison is successful or all enrolled fingerprint images in the first screening result fail to pass the comparison, in response to at least one of: a result of a current rough matching failing to meet a second preset condition; and a result of a current precise matching failing to meet a third preset condition.

In still other embodiments, the result of the rough alignment includes: a comparison result of directional features of the fingerprint image to be compared and the enrolled fingerprint image after or before the fingerprint image to be compared and/or the enrolled fingerprint image are rotated; and the first preset condition includes at least one of: a similarity of the directional features greater than or equal to a first preset threshold; and a voting concentration of the directional features greater than or equal to a second preset threshold.

In some embodiments, the rough alignment includes a rotational alignment; and the precise alignment includes a displacement alignment.

In other embodiments, the result of the rough matching includes a feature point similarity; and the second preset condition includes: the feature point similarity greater than or equal to a third preset threshold.

In still other embodiments, the result of the precise matching includes a feature point similarity; and the third preset condition includes: the feature point similarity greater than or equal to a fourth preset threshold.

In some embodiments, the one part of feature point pairs include feature point pairs at peaks, and the other part of feature point pairs include feature point pairs at valleys; or the one part of feature point pairs and the other part of feature point pairs are selected in a jump-point mode.

In other embodiments, the fingerprint image to be compared is collected by a fingerprint sensor with a length and a width both less than or equal to 4 mm.

In a second aspect, the present disclosure provides a device for fingerprint comparison, comprising: a fingerprint sensor configured to collect a fingerprint image to be compared; and a processor configured to: acquire the fingerprint image to be compared; perform a first-stage fingerprint comparison on the fingerprint image to be compared and an enrolled fingerprint image; determine, according to a result of the first-stage fingerprint comparison, whether to perform a second-stage fingerprint comparison on the fingerprint image to be compared and the enrolled fingerprint image; and determine, according to the result of the first-stage fingerprint comparison or a result of the second-stage fingerprint comparison, whether the comparison between the fingerprint image to be compared and the enrolled fingerprint image is successful.

In some embodiments, the first-stage fingerprint comparison includes a rough alignment and/or a rough matching; and the second-stage fingerprint comparison includes at least one of a precise alignment, a rough matching and a precise matching.

In other embodiments, the first-stage fingerprint comparison includes a rough alignment; and the second-stage fingerprint comparison includes a precise alignment.

In still other embodiments, the first-stage fingerprint comparison further includes a rough matching, and while performing the first-stage fingerprint comparison, the processor is further configured to: perform the rough matching on the enrolled fingerprint image and the fingerprint image to be compared which have been subjected to the precise alignment, where the rough matching includes performing a feature matching on one part of feature point pairs in an overlap region between the enrolled fingerprint image and the fingerprint image to be compared, and the feature point pair includes a feature point on the fingerprint image to be compared and a corresponding feature point on the enrolled fingerprint image in the overlap region; the second-stage fingerprint comparison further includes a precise matching, and when determining whether to perform the second-stage fingerprint comparison, the processor is further configured to: determine, according to a result of the rough matching, whether to perform the precise matching on the enrolled fingerprint image and the fingerprint image to be compared, where the precise matching includes performing a feature matching on the other part of feature point pairs in the overlap region; and when determining whether the comparison is successful, the processor is further configured to: determine, according to a result of the precise matching, whether the comparison between the fingerprint image to be compared and the enrolled fingerprint image is successful.

In some embodiments, a plurality of enrolled fingerprint images are provided, and the processor is further configured to: acquire a next enrolled fingerprint image, until the comparison is successful or all enrolled fingerprint images fail to pass the comparison, in response to any one of: a result of a current rough alignment failing to meet a first preset condition; a result of a current rough matching failing to meet a second preset condition; and a result of a current precise matching failing to meet a third preset condition.

In other embodiments, a plurality of enrolled fingerprint images are provided, and the processor is further configured to: perform a rough alignment on the fingerprint image to be compared and the plurality of enrolled fingerprint images, respectively; and perform a first screening on the plurality of enrolled fingerprint images according to a result of each rough alignment to obtain a first screening result, where the first screening result includes enrolled fingerprint images of which the result of the rough alignment meets a first preset condition.

In still other embodiments, the processor is further configured to: perform a precise alignment and a rough matching on each enrolled fingerprint image in the first screening result and the fingerprint image to be compared; perform, according to a result of the rough matching of each enrolled fingerprint image in the first screening result, a second screening on the first screening result to obtain a second screening result, where the second screening result includes enrolled fingerprint images of which the result of the rough matching meets a second preset condition; perform a precise matching on the other part of feature point pairs corresponding to each enrolled fingerprint image in the second screening result; and determine, according to a result of each precise matching, whether the enrolled fingerprint image in the second screening result is successfully compared with the fingerprint image to be compared.

In some embodiments, the processor is further configured to: perform a precise alignment and a rough matching on any enrolled fingerprint image in the first screening result and the fingerprint image to be compared; or rank, according to a comparison result of results of rough alignments in the first screening result, the enrolled fingerprint images in the first screening result, and sequentially perform a precise alignment and a rough matching on the enrolled fingerprint images in the first screening result.

In other embodiments, the processor is further configured to: acquire a next enrolled fingerprint image in the first screening result, until the comparison is successful or all enrolled fingerprint images in the first screening result fail to pass the comparison, in response to at least one of: a result of a current rough matching failing to meet a second preset condition; and a result of a current precise matching failing to meet a third preset condition.

In still other embodiments, the result of the rough alignment includes: a comparison result of directional features of the fingerprint image to be compared and the enrolled fingerprint image after or before the fingerprint image to be compared and/or the enrolled fingerprint image are rotated; and the first preset condition includes at least one of: a similarity of the directional features greater than or equal to a first preset threshold; and a voting concentration of the directional features greater than or equal to a second preset threshold.

In some embodiments, the rough alignment includes a rotational alignment; and the precise alignment includes a displacement alignment.

In other embodiments, the result of the rough matching includes a feature point similarity; and the second preset condition includes: the feature point similarity greater than or equal to a third preset threshold.

In still other embodiments, the result of the precise matching includes a feature point similarity; and the third preset condition includes: the feature point similarity greater than or equal to a fourth preset threshold.

In some embodiments, the one part of feature point pairs include feature point pairs at peaks, and the other part of feature point pairs include feature point pairs at valleys; or the one part of feature point pairs and the other part of feature point pairs are selected in a jump-point mode.

In a third aspect, the present disclosure provides an electronic device for fingerprint comparison, comprising: a processor; and a memory having program instructions for fingerprint comparison stored thereon which, when executed by the processor, cause the electronic device to implement any method according to the first aspect of the present disclosure.

In a fourth aspect, the present disclosure provides a non-transitory computer-readable storage medium having a program for fingerprint comparison stored thereon which, when executed by a processor, causes any method according to the first aspect of the present disclosure to be implemented.

According to the above solution for fingerprint comparison, in the embodiments of the present disclosure, the fingerprint comparison process is divided into a first-stage fingerprint comparison and a second-stage fingerprint comparison, and whether to perform the second-stage fingerprint comparison is determined according to the result of the first-stage fingerprint comparison, so that some of the second-stage fingerprint comparison can be omitted under certain conditions. In other words, the data volume in the second-stage fingerprint comparison can be reduced to a certain extent, thereby facilitating improvement of the fingerprint comparison speed.

Further, in some embodiments, the first-stage fingerprint comparison may include a rough alignment, and the second-stage fingerprint comparison may include a precise alignment. By determining whether to perform a precise alignment according to a result of the rough alignment, subsequent precise alignment and the like may be omitted for an enrolled fingerprint image with a poor rough alignment result, thereby helping to increase the processing speed of fingerprint alignment.

Further, in other embodiments, the first-stage fingerprint comparison may include a rough matching, and the second-stage fingerprint comparison may include a precise matching. By determining whether to perform a precise matching according to a result of the rough matching, subsequent precise matching may be omitted for an enrolled fingerprint image with a poor rough matching result, thereby helping to increase the processing speed of fingerprint matching.

### BRIEF DESCRIPTION OF THE DRAWINGS

The above and other objectives, features and advantages of the exemplary embodiments of the present disclosure will become readily apparent from the following detailed description, which proceeds with reference to the accompanying drawings. In the accompanying drawings, several embodiments of the present disclosure are illustrated by way of example but not limitation, and like or corresponding reference numerals indicate like or corresponding parts, in which:

FIG. 1 is a schematic flowchart of an existing solution for fingerprint comparison;

FIG. 2 is a schematic flowchart of a method for fingerprint comparison according to an embodiment of the present disclosure;

FIG. 3 is a schematic flowchart of a method in which the first-stage fingerprint comparison includes a rough matching according to an embodiment of the present disclosure;

FIG. 4 is a schematic diagram of a fingerprint comparison process including a first screening according to an embodiment of the present disclosure;

FIG. 5 is a schematic diagram of a fingerprint comparison process including a first screening according to another embodiment of the present disclosure;

FIG. 6 is a schematic diagram of a fingerprint comparison process according to yet another embodiment of the present disclosure;

FIG. 7 is a schematic block diagram of a device for fingerprint comparison according to an embodiment of the present disclosure; and

FIG. 8 is a schematic block diagram of an electronic device according to an embodiment of the present disclosure.

### DETAIL DESCRIPTION

The technical solutions in the embodiments of the present disclosure will be clearly and completely described below with reference to the accompanying drawings in the embodiments of the present disclosure. Apparently, the described embodiments are only some of the embodiments of the present disclosure, but not all of them. All other embodiments, which can be derived by those skilled in the art from the embodiments of the present disclosure without making any creative effort, shall fall within the protection scope of the present disclosure.

It will be understood that the terms “comprise” and “include,” when used in the description and claims of the present disclosure, specify the presence of stated features, integers, steps, operations, elements, and/or components, but do not preclude the presence or addition of one or more other features, integers, steps, operations, elements, components, and/or combinations thereof.

It is also to be understood that the terminology used in the description of the disclosure herein is for the purpose of describing particular embodiments only, and is not intended to limit the disclosure. As used in the description and claims of the disclosure, the singular forms “a”, “an” and “the” are intended to include the plural forms as well, unless the context clearly indicates otherwise. It should be further understood that the term “and/or” as used in the description and claims of the disclosure refers to any and all possible combinations of one or more of the associated listed items and includes such combinations.

As used in the description and the claims, the term “if” may be interpreted contextually as “when . . . ” or “once” or “in response to determining” or “in response to detecting.” Similarly, the phrase “if it is determined” or “if [the described condition or event] is detected” may be interpreted contextually as meaning “upon determining” or “in response to determining” or “upon detecting [the described condition or event]” or “in response to detecting [the described condition or event].”

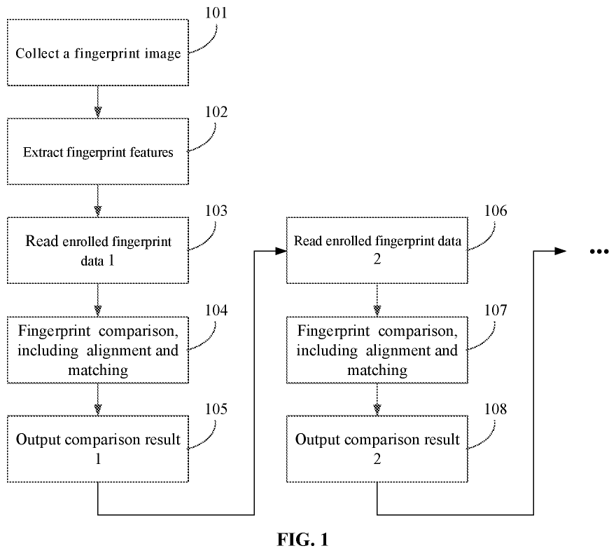

The present inventors have found that, whether to perform fingerprint verification based on a fingerprint image collected by a large fingerprint sensor or by a small fingerprint sensor, a comparison result between each piece of enrolled fingerprint data and the data of the fingerprint to be compared can be obtained only by performing alignment and matching on each piece of enrolled fingerprint data and the data of the fingerprint to be compared. This will be exemplarily described below with reference to FIG. 1.

FIG. 1 is a schematic flowchart of an existing solution for fingerprint comparison. As shown in FIG. 1, in step 101, a fingerprint image to be compared may be collected by a fingerprint sensor. In the application scene of a small fingerprint sensor, the fingerprint image to be compared is a fingerprint image that covers a small area of fingerprint. Next, in step 102, feature extraction may be performed on the collected fingerprint image to be compared to obtain fingerprint feature data.

Then, the process may proceed to step 103, where a first piece of enrolled fingerprint data 1 is read. The first piece of enrolled fingerprint data 1 includes at least feature information of a first enrolled fingerprint image. Next, in step 104, the first piece of enrolled fingerprint data 1 is compared with the fingerprint feature data of the fingerprint image to be compared that was extracted in step 102, which includes performing alignment and matching on the first piece of enrolled fingerprint data 1 and the fingerprint feature data of the fingerprint image to be compared. Then, in step 105, a comparison result 1 for the first piece of enrolled fingerprint data 1 is output. The comparison result 1 may include a similarity score, or a classification result that indicates whether the comparison is successful.

As further shown in FIG. 1, in step 106, a second piece of enrolled fingerprint data 2 may be read, and then a comparison result 2 is output through the comparison process in step 107 and step 108. Steps 106 to 108 are performed in a similar manner to steps 103 to 105, which are not repeated here. When there are more pieces of enrolled fingerprint data, a similar comparison process may be further executed, which is not described in detail here.

In some application scenes, after all pieces of the enrolled fingerprint data are compared with the data of the fingerprint feature to be compared one by one, an optimal result (for example, the one with the highest similarity score) is selected from all the obtained comparison results as the final comparison result of the current fingerprint image to be compared. For each piece of enrolled fingerprint data, the comparison result can be obtained only after all alignments and matchings are completed in the fingerprint comparison process.

In view of this, an embodiment of the present disclosure provides a solution for fingerprint comparison which divides a conventional fingerprint comparison process into a first-stage fingerprint comparison and a second-stage fingerprint comparison, so that the second-stage fingerprint comparison becomes a step conditionally executed. Furthermore, when the second-stage fingerprint comparison is omitted sometimes, a possible low-probability comparison in the comparison process is effectively reduced, thereby facilitating improvement of the comparison speed and efficiency in the fingerprint comparison process. Specific embodiments of the present disclosure will be described in detail below with reference to the accompanying drawings.

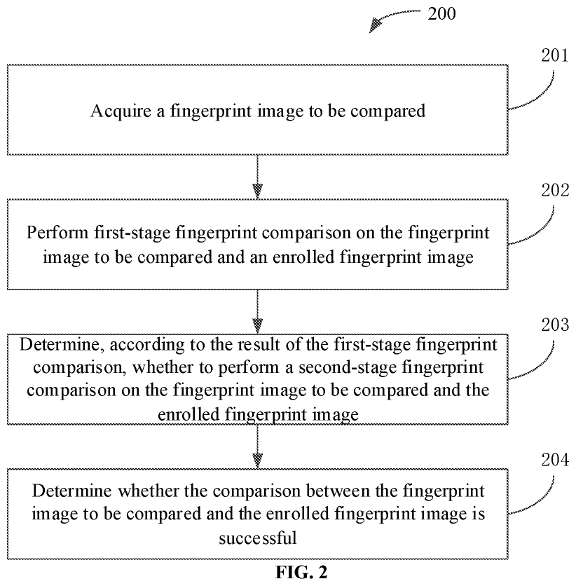

FIG. 2 is a schematic flowchart of a method for fingerprint comparison according to an embodiment of the present disclosure. As shown in FIG. 2, a method 200 may comprise the following steps 201 to 204. In step 201, a fingerprint image to be compared is acquired. In some embodiments, the fingerprint image to be compared may be acquired via a small fingerprint sensor. In other embodiments, the fingerprint image to be compared may be collected by a fingerprint sensor with a length and a width both less than or equal to 4 mm.

Next, in step 202, a first-stage fingerprint comparison may be performed on the fingerprint image to be compared and an enrolled fingerprint image. In some embodiments, the first-stage fingerprint comparison may include a rough alignment and/or a rough matching.

In some embodiments, the rough alignment may include a rough comparison of feature point groups in the fingerprint image to be compared and the enrolled fingerprint image. In other embodiments, the rough alignment may include a rough comparison of features such as ridge or valley orientations and/or fingerprint profiles of the fingerprint image to be matched and the enrolled fingerprint image. In still other embodiments, the rough alignment may include a rotational alignment or a displacement alignment.

The rotational alignment may include a comparison of directional features. The directional features may include directional angles of feature points or feature point groups in the fingerprint image. For example, all possible rotation angles of the enrolled fingerprint image and/or the fingerprint image to be compared may be enumerated in an enumeration method and then, for example, voted in a voting method, where rotation angles with centralized votes of a count which exceeds a certain threshold are determined as a result of the rotational alignment. For another example, after all possible rotation angles are selected in the enumeration method, a similarity between feature point groups of the two at each rotation angle may be scored, and the result of the rotational alignment may be obtained through threshold screening. The possible rotation angle in the rotational alignment may be selected in a range from 0° to 360°, and assuming that the rotation is in units of 1° (degree), there may be 360 rotation angles.

Specifically, taking the rotation of the fingerprint image to be compared as an example, before the rotation (when the fingerprint image to be compared is rotated by 0°), voting and/or a rough similarity comparison may be performed on the fingerprint image to be compared and an enrolled fingerprint image. Then, the fingerprint image to be compared may be rotated by 1°, 2°, or the like in sequence, and subjected to the voting and/or rough similarity comparison with the enrolled fingerprint image. Finally, an optimal voting result and/or similarity result is selected from a plurality of voting results and/or similarity results before the fingerprint image to be compared is rotated and after the fingerprint image to be compared is rotated by each angle, as the result of the rotational alignment. It will be understood that during the rotational alignment, instead of the fingerprint image to be compared, the enrolled fingerprint image may be rotated as needed, or both the fingerprint image to be compared and the enrolled fingerprint image may be rotated.

In some embodiments, a displacement alignment may include a comparison of position features. The position features may include position coordinates or relative position information of feature points or feature point groups in the fingerprint images, and the like. For example, an enumeration method may be used to select all possible relative displacements between the enrolled fingerprint image and the fingerprint image to be compared, and then a voting method may be used to vote for all possible relative displacements of the two, and relative displacements with centralized votes of a count which exceeds a certain threshold are determined as a result of the displacement alignment. For another example, after all possible relative displacements are selected in the enumeration method, a rough similarity between feature point groups of the two at each relative displacement may be scored, and the result of the displacement alignment may be obtained through threshold screening. The possible relative displacements in the displacement alignment may include various combinations, and, assuming that the displacement is in units of 1 mm (millimeter), may include 1 mm to left, 1 mm up, 1 mm down, 1 mm to right, 2 mm to left, 2 mm up, and various combinations thereof.

Specifically, taking the displacement of the fingerprint image to be compared as an example, before the displacement, voting and/or a similarity comparison may be performed on the fingerprint image to be compared and an enrolled fingerprint image. Then, the fingerprint image to be compared may be sequentially displaced 1 mm to left, 1 mm up, 1 mm down, 1 mm to right, 2 mm to left, 2 mm up, or various combinations thereof, and each displaced fingerprint image is subjected to the voting and/or similarity comparison with the enrolled fingerprint image. Finally, an optimal voting result and/or similarity result is selected from a plurality of voting results and/or similarity results before the fingerprint image to be compared is displaced and after the fingerprint image to be compared is displaced in various manners, as the result of the displacement alignment. It will be understood that during the displacement alignment, instead of the fingerprint image to be compared, the enrolled fingerprint image may be displaced as needed, or both the fingerprint image to be compared and the enrolled fingerprint image may be displaced.

In an embodiment of the present disclosure, the rough matching may include performing a feature matching on one part of feature point pairs in an overlap region between the enrolled fingerprint image and the fingerprint image to be compared, and the feature point pair may include a feature point on the fingerprint image to be compared and a corresponding feature point on the enrolled fingerprint image in the overlap region. In other embodiments, the overlap region may be a feature overlap region between the enrolled fingerprint image and the fingerprint image to be compared after the alignment. In still other embodiments, the one part of feature point pairs may be randomly selected. The rough matching may be a feature similarity comparison performed on each selected feature point pair.

After the first-stage fingerprint comparison is performed and the result of the first-stage fingerprint comparison is obtained, the process may proceed to step 203, where according to the result of the first-stage fingerprint comparison, it may be determined whether to perform a second-stage fingerprint comparison on the fingerprint image to be compared and the enrolled fingerprint image. In some embodiments, in response to that the result of the first-stage fingerprint comparison meets a preset condition, the second-stage fingerprint comparison may be performed on the fingerprint image to be compared and the enrolled fingerprint image; and in response to that the result of the first-stage fingerprint comparison does not meet the preset condition, the second-stage fingerprint comparison may not be performed.

In some embodiments, the second-stage fingerprint comparison may include at least one of a precise alignment, a rough matching and a precise matching. In other embodiments, the first-stage fingerprint comparison may include a rough alignment; and the second-stage fingerprint comparison may include a precise alignment. In still other embodiments, the first-stage fingerprint comparison may include an alignment (such as a rough alignment and a precise alignment), and the second-stage fingerprint comparison may include a rough matching. In some embodiments, the first-stage fingerprint comparison may include a rough alignment, and the second-stage fingerprint comparison may include a precise alignment and a rough matching. In other embodiments, the first-stage fingerprint comparison may include a rough alignment, and the second-stage fingerprint comparison may include a precise alignment, a rough matching and a precise matching. In some embodiments, the first-stage fingerprint comparison may include a rough matching, and the second-stage fingerprint comparison may include a precise matching.

In other embodiments, the first-stage fingerprint comparison may include various kinds of processing, and the second-stage fingerprint comparison may also include various kinds of processing. In this case, the method according to the embodiments of the present disclosure may be not limited to performing the second-stage fingerprint comparison only after the first-stage fingerprint comparison is totally completed, but may perform the first-stage fingerprint comparison and the second-stage fingerprint comparison for multiple times. For example, after one kind of processing in the first-stage fingerprint comparison is performed, it may be determined whether to perform a corresponding kind of processing in the second-stage fingerprint comparison. Then, another kind of processing in the first-stage fingerprint comparison may be performed, and it may be determined whether to perform another kind of processing in the second-stage fingerprint comparison.

Specifically, for example, the first-stage fingerprint comparison may include a rough alignment and a rough matching, and the second-stage fingerprint comparison may include a precise alignment and precise matching. Therefore, in the method provided in the embodiments of the present disclosure, the rough alignment in the first-stage fingerprint comparison may be firstly performed, and then it is determined whether to perform the precise alignment in the second-stage fingerprint comparison. Then, the enrolled fingerprint image, which has been subjected to the precise alignment, may be subjected to the rough matching in the first-stage fingerprint comparison, and it is determined whether to perform the precise matching in the second-stage fingerprint comparison.

In some embodiments, the rough alignment may include a rotational alignment; and the precise alignment may include a displacement alignment. Compared to a displacement alignment, a rotational alignment has a limited selection range of rotation angles, so that the data computation amount for a rotational alignment is generally smaller than the data computation amount for a displacement alignment. Therefore, compared with the case where the first-stage fingerprint comparison is a displacement alignment and the second-stage fingerprint comparison is a rotational alignment, the case where the first-stage fingerprint comparison is a rotational alignment and the second-stage fingerprint comparison is a displacement alignment can further reduce the overall data processing amount in the fingerprint comparison, and thereby further facilitate improvement of the comparison speed of the fingerprint comparison.

As further shown in FIG. 2, the method 200 may further include step 204. In step 204, according to the result of the first-stage fingerprint comparison or the result of the second-stage fingerprint comparison, it may be determined whether the comparison between the fingerprint image to be compared and the enrolled fingerprint image is successful. In some embodiments, in response to that the result of the first-stage fingerprint comparison does not meet a preset condition, it is determined that the comparison between the fingerprint image to be compared and the enrolled fingerprint image is failed; in response to that the result of the second-stage fingerprint comparison meets a preset condition, it is determined that the comparison between the fingerprint image to be compared and the enrolled fingerprint image is successful; and in response to that the result of the second-stage fingerprint comparison does not meet the preset condition, it is determined that the comparison between the fingerprint image to be compared and the enrolled fingerprint image is failed.

In other embodiments, in response to that the comparison between the fingerprint image to be compared and the current enrolled fingerprint image is failed, a next enrolled fingerprint image may be acquired for a further comparison. In still other embodiments, the step 204 may include: determine, according to the result of the first-stage fingerprint comparison or the result of the second-stage fingerprint comparison between the fingerprint image to be compared and each of a plurality of enrolled fingerprint images, whether the enrolled fingerprint image successfully compared with the fingerprint image to be compared is present in the plurality of enrolled fingerprint images.

While the method for fingerprint comparison according to an embodiment of the present disclosure is exemplarily described above with reference to FIG. 2, it will be understood that the above description is exemplary and not restrictive. For example, the step 201 may not be limited to acquiring the fingerprint image to be compared via a small fingerprint sensor (such as a capacitive slider sensor). In other embodiments, the fingerprint image to be compared may be acquired via a large fingerprint sensor (such as an optical sensor, a capacitive pressure sensor, or the like). In other words, the application range of the method provided in the embodiments of the present disclosure may be not limited to small fingerprint sensors, but may be expanded to large fingerprint sensors as needed, to further increase the speed of fingerprint verification based on a large fingerprint sensor.

It will be further understood that according to the method provided in the embodiments of the present disclosure, by dividing a conventional fingerprint comparison process into a first-stage fingerprint comparison and a second-stage fingerprint comparison, when the result of the first-stage fingerprint comparison does not meet a preset condition, the subsequent second-stage fingerprint comparison may be omitted. Therefore, the comparison process of some enrolled fingerprint images can be reduced, and the speed and efficiency of fingerprint comparison can be improved.

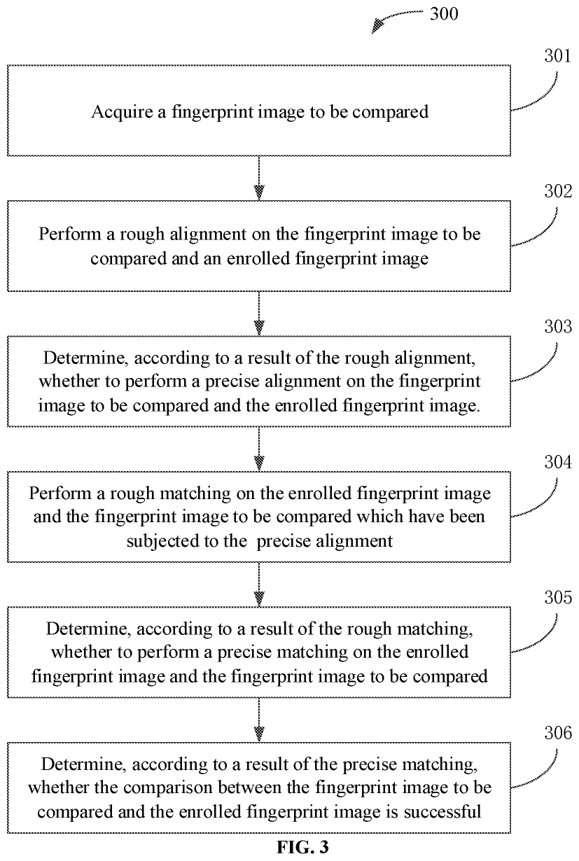

FIG. 3 is a schematic flowchart of a method in which the first-stage fingerprint comparison includes a rough matching according to an embodiment of the present disclosure. As will be understood from the following description, the method 300 shown in FIG. 3 may be an embodied representation of the method 200 described above in conjunction with FIG. 2. Therefore, the above description of the method 200 in conjunction with FIG. 2 may also be applicable to the description of the method 300 below.

As shown in FIG. 3, the method 300 may include steps 301 to 306. In step 301, a fingerprint image to be compared may be acquired. The step 301 may be the same as or similar to the step 201 described above in conjunction with FIG. 2, and is not repeated here. Next, in step 302, when the first-stage fingerprint comparison includes a rough alignment, the rough alignment is performed on the fingerprint image to be compared and an enrolled fingerprint image. The step 302 may be a specific implementation of the step 202 described above in conjunction with FIG. 2. The rough alignment has been described in detail above in conjunction with FIG. 2, and is not repeated here.

Then, the process may proceed to step 303, where according to a result of the rough alignment, it may be determined whether to perform a precise alignment on the fingerprint image to be compared and the enrolled fingerprint image. The rough alignment may include one of a rotational alignment and a displacement alignment, and the precise alignment may include the other one of a rotational alignment and a displacement alignment. In some embodiments, the rough alignment may include a rotational alignment, and the result of the rough alignment may include: a comparison result of directional features of the fingerprint image to be compared and the enrolled fingerprint image after or before the fingerprint image to be compared and/or the enrolled fingerprint image are rotated.

In other embodiments, in response to that the result of the rough alignment meets a first preset condition, a precise alignment is performed on the fingerprint image to be compared and the enrolled fingerprint image; and in response to that the result of the rough alignment does not meet the first preset condition, the precise alignment is not performed. In still other embodiments, the first preset condition may include at least one of: a similarity of the directional features greater than or equal to a first preset threshold; a voting concentration of the directional features greater than or equal to a second preset threshold; and the like. The first preset threshold and the second preset threshold may be set as needed.

In still other embodiments, the first-stage fingerprint comparison may further include a rough matching, and the second-stage fingerprint comparison may further include a precise matching. Specifically, as further shown in FIG. 3, in step 304, a rough matching may be performed on the enrolled fingerprint image and the fingerprint image to be compared which have been subjected to the precise alignment. The rough matching may include performing a feature matching on one part of feature point pairs in an overlap region between the enrolled fingerprint image and the fingerprint image to be compared, and the feature point pair may include a feature point on the fingerprint image to be compared and a corresponding feature point on the enrolled fingerprint image in the overlap region.

For the enrolled fingerprint image which has been subjected to a precise alignment in step 303, step 304 may be further performed with the fingerprint image to be compared. If the enrolled fingerprint image has not been subjected to a precise alignment in step 303, then step 304 and subsequent operations may be omitted. In some embodiments, for the enrolled fingerprint image which has been subjected to a precise alignment, a rotation angle and a relative displacement between the enrolled fingerprint image and the fingerprint image to be compared may be obtained, and an overlap region of the enrolled fingerprint image and the fingerprint image to be compared may be obtained by performing related operations on the two according to the calculated rotation angle and relative displacement. By acquiring feature points at corresponding positions of the fingerprint image to be compared and the enrolled fingerprint image in the overlap region, a plurality of feature point pairs can be formed. In some embodiments, each feature point pair may include a feature point from the fingerprint image to be compared and a corresponding feature point on the enrolled fingerprint image.

The feature matching on the one part of feature point pairs may include feature matching on each of the one part of feature point pairs. In other words, a similarity between two feature points in each feature point pair is calculated to obtain a matching result of the feature point pair, and further obtain a result of whether the one part of feature point pairs are matched as a whole. In some embodiments, the one part of feature point pairs may be randomly selected. In other embodiments, a count of the one part of feature point pairs may take 50% of all feature point pairs in the overlap region. In still other embodiments, a count of the one part of feature point pairs may take more or less than 50% of all feature point pairs in the overlap region.

During the rough matching, one part of the feature point pairs in the overlap region may be subjected to feature similarity comparison, while the other part of the feature point pairs may be not subjected to feature similarity comparison now. According to such arrangement, there is no need to perform feature comparison on all feature point pairs at one time, thereby reducing the comparison data amount in step 304. Further, with the matching results of the one part of feature point pairs, a similarity degree between the fingerprint image to be compared and the enrolled fingerprint image can be roughly evaluated. As a result, subsequent comparison operations on an enrolled fingerprint image with a lower similarity degree can be omitted, thereby saving the comparison time. Based on such a technical concept, in the method 300 provided in the embodiments of the present disclosure, a conventional matching process is divided into a rough matching and a precise matching, which will be further explained below with reference to step 305.

In step 305, according to a result of the rough matching, it may be determined whether to perform a precise matching on the enrolled fingerprint image and the fingerprint image to be compared. The precise matching may include performing a feature matching on the other part of feature point pairs in the overlap region. In some embodiments, the result of the rough matching may include a feature point similarity, which may be a result obtained by performing similarity computation on the one part of feature point pairs.

In other embodiments, in response to that the result of the rough matching meets a second preset condition, it is determined to perform the precise matching; and in response to that the result of the rough matching does not meet the second preset condition, it is determined not to perform the precise matching. In still other embodiments, the second preset condition may include the feature point similarity greater than or equal to a third preset threshold. The third preset threshold may be set as needed.

In some embodiments, the one part of feature point pairs may include feature point pairs at peaks, and the other part of feature point pairs may include feature point pairs at valleys. In other embodiments, the one part of feature point pairs may include feature point pairs at valleys, and the other part of feature point pairs may include feature point pairs at peaks. The peaks may be understood as ridge lines of the fingerprint, and the valleys may be understood as valley lines of the fingerprint.

In other embodiments, the one part of feature point pairs and the other part of feature point pairs may be selected in a jump-point mode. In other words, the feature point pairs may be selected in a staggered manner. For example, the feature point pairs in the overlap region may be numbered in a certain order. The one part of feature point pairs may be odd-numbered feature point pairs, and the other part of feature point pairs may be even-numbered feature point pairs.

Further, in step 306, according to a result of the precise matching, it may be determined whether the comparison between the fingerprint image to be compared and the enrolled fingerprint image is successful. In some embodiments, the result of the precise matching may include a feature point similarity, which may be calculated in a method the same as or similar to that of the rough matching and is not repeated here. In other embodiments, whether the comparison is successful may be determined according to whether the result of the precise matching meets a third preset condition. Specifically, in response to that the result of the precise matching meets the third preset condition, it may be determined that the fingerprint image to be compared and the enrolled fingerprint image are successfully matched (or successfully compared); and in response to that the result of the precise matching does not meet the third preset condition, it may be determined that the fingerprint image to be compared and the enrolled fingerprint image fail to be matched (or fail to pass the comparison). In still other embodiments, the third preset condition may include the feature point similarity greater than or equal to a fourth preset threshold. The fourth preset threshold may be set as needed.

While a specific implementation of the method for fingerprint comparison according to an embodiment of the present disclosure is exemplarily described above with reference to FIG. 3, it will be understood that by dividing a conventional alignment process into a rough alignment and a precise alignment, and by dividing a conventional matching process into a rough matching and a precise matching, subsequent comparison processes on an enrolled fingerprint image with a lower hit probability (probability of successful comparison) during the comparison are omitted, thereby facilitating improvement of the comparison speed. A specific explanation is given below.

In the conventional comparison process, assuming that for each enrolled fingerprint image, a computing time L is desired for performing complete alignment computation (including a rotational alignment and a displacement alignment), and a computing time M is desired for performing complete matching computation (i.e., performing similarity computation for all feature point pairs at a time), the computing time for comparing N enrolled fingerprint images is (L+M)*N.

In the method according to the embodiment of the present disclosure, for each enrolled fingerprint image, it is assumed that the rough alignment takes a computing time L1, the precise alignment takes a computing time L2, the rough matching takes a computing time M1, and the precise matching takes a computing time M2. In addition, it is assumed that dividing the rough alignment and the precise alignment takes an additional computing time C_{L}, and dividing the rough matching and the precise matching takes an additional computing time C_{M}. However, in the computation process by a computer, the dividing processes take much less time than the alignment computing time and the matching computing time, that is, C_{L}<<L, and C_{M}<<M. Then, it may be deemed that L=L1+L2+C_{L}, and M=M1+M2+C_{M}.

Further, assuming that a probability of the enrolled fingerprint image subjected to the precise alignment after rough alignment is P_{L}, and a probability of the enrolled fingerprint image subjected to the precise matching after a rough matching is P_{M}, then in the method provided in the embodiments of the present disclosure, a computing time N*((L1+C_{L})+P_{L}*(L2+M1+C_{M})+P_{L}*P_{M}*M2) is desired for comparing N enrolled fingerprint images. Since both probabilities P_{L} and P_{M} are numerical values less than 1, N*((L1+C_{L})+P_{L}*(L2+M1+C_{M})+P_{L}*P_{M}*M2)<N*((L1+C_{L})+(L2+M1+C_{M})+M2)=N*(L1+C_{L}+L2+M1+C_{M}+M2)=N*(L+M). Therefore, according to the derivation of the formula, it can be seen that the method provided in the embodiments of the present disclosure takes a shorter comparison time than the conventional comparison process.

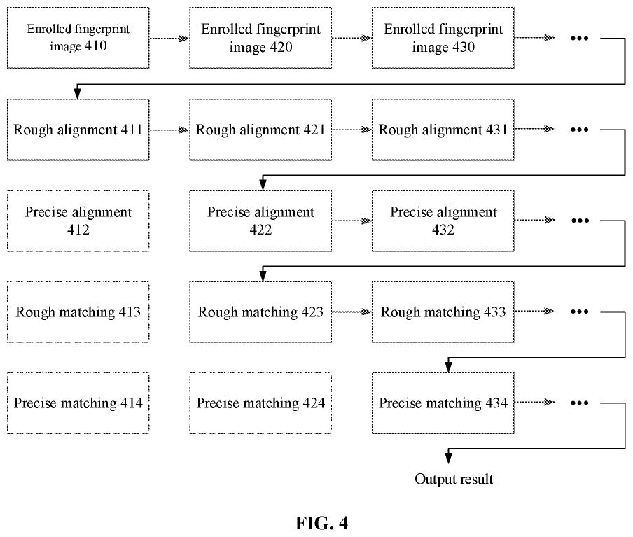

As can be seen from the above analysis, when comparing N enrolled fingerprint images, the method provided in the embodiments of the disclosure takes less time to obtain the final result than the conventional comparison process. To facilitate further understanding, further description will be given below in conjunction with FIG. 4.

FIG. 4 is a schematic diagram of a fingerprint comparison process including a first screening according to an embodiment of the present disclosure. As shown in FIG. 4, when fingerprint comparison is performed on a plurality of enrolled fingerprint images (e.g., enrolled fingerprint images 410, 420, 430, and the like in the figure), according to the method provided in the embodiments of the present disclosure, rough alignments 411, 421, 431, and the like in the first-stage fingerprint comparison may be performed on the fingerprint image to be compared and the enrolled fingerprint images 410, 420, 430, and the like read from the figure, respectively. Then, the first screening may be performed on the plurality of enrolled fingerprint images 410, 420, 430, and the like according to the result of each rough alignment to obtain a first screening result. The first screening result may include enrolled fingerprint images of which the result of the rough alignment meets a first preset condition.

Assuming that in the first screening, the results of rough alignments 421, 431 and the like meet the first preset condition, while the result of rough alignment 411 does not meet the first preset condition, the first screening result includes the enrolled fingerprint images 420, 430 and the like, but not the enrolled fingerprint image 410.

Next, the precise alignment in the second-stage fingerprint comparison and the rough matching in the first-stage fingerprint comparison may be performed on each enrolled fingerprint image in the first screening result and the fingerprint image to be compared. For example, as shown in the figure, the enrolled fingerprint image 420 may be further subjected to a precise alignment 422 and a rough matching 423, and the enrolled fingerprint image 430 may be further subjected to a precise alignment 432 and a rough matching 433, while the enrolled fingerprint image 410 outside of the first screening result is not subjected to a precise alignment 412 (shown in a dashed box) and a rough matching 413 (shown in a dashed box).

Then, according to the result of the rough matching of each enrolled fingerprint image in the first screening result, a second screening may be performed on the first screening result to obtain a second screening result. The second screening result may include enrolled fingerprint images of which the result of the rough matching meets a second preset condition. Specifically, in the embodiment shown in FIG. 4, the first screening result includes the enrolled fingerprint images 420, 430, and the like, and after the rough matching 423 and the rough matching 433 are respectively performed, it may be judged whether the result of the rough matching 423 and the result of the rough matching 433 meet the second preset condition, respectively. Assuming that the result of the rough matching 423 does not meet the second preset condition and the result of the rough matching 433 meets the second preset condition, the second screening result does not include the enrolled fingerprint image 420, but includes the enrolled fingerprint image 430 and the like.

Further, the precise matching in the second-stage fingerprint comparison may be performed on the other part of feature point pairs corresponding to each enrolled fingerprint image in the second screening result; and according to the result of each precise matching, it may be determined whether the enrolled fingerprint image in the second screening result is successfully compared with the fingerprint image to be compared. For example, a precise matching 434 and the like may be further performed on the enrolled fingerprint image 430 and the like in the second screening result shown in the figure, while a precise matching 424 (shown in a dashed box) is not performed on the enrolled fingerprint image 420 outside of the second screening result, and a precise matching 414 (shown in a dashed box) is not performed on the enrolled fingerprint image 410.

In some embodiments, after the result of the precise matching for each enrolled fingerprint image in the second screening result is obtained, an enrolled fingerprint image corresponding to an optimal result in all the results of the precise matching may be determined as the enrolled fingerprint image successfully compared with the fingerprint image to be compared. In other embodiments, determining whether the comparison is successful may include: determining whether the comparison is successful according to whether a result that meets a third preset condition is present in the results of the precise matching. In still other embodiments, in response to the presence of a result of the precise matching that meets the third preset condition, it is determined that the enrolled fingerprint image corresponding to the result is successfully compared with the fingerprint image to be compared; and in response to the absence of a result of the precise matching that meets the third preset condition, it is determined that none of the enrolled fingerprint images is successfully compared with the fingerprint image to be compared.

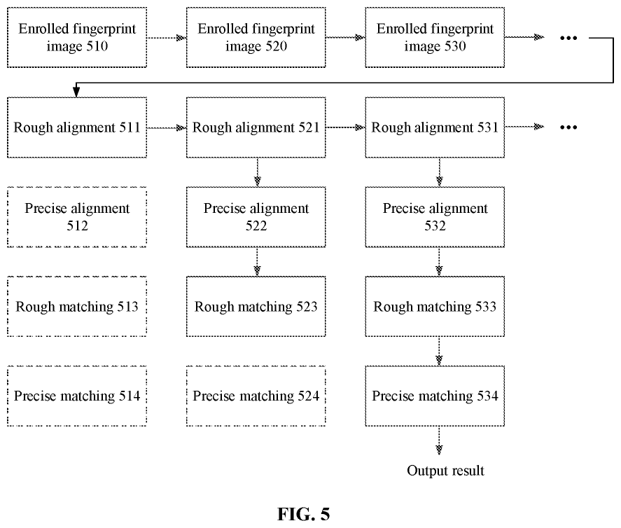

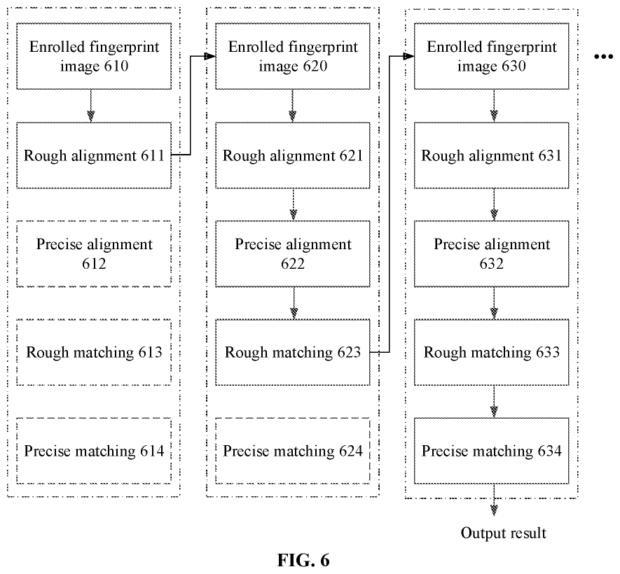

While a specific embodiment of the present disclosure has been exemplarily described above with reference to FIG. 4, it will be understood that the above description is exemplary and not restrictive. For example, the number of enrolled fingerprint images may not be limited to three as shown, and may be provided more or less as needed. For another example, omission of the precise alignment 412, the rough matching 413, and the precise matchings 414 and 424 are exemplary, and more or less processing may be omitted depending on the actual application. It will be further understood that compared with the conventional comparison process where all the processing steps in the figures are performed, the method provided in the embodiments of the present disclosure may omit, for example, the precise alignment 412, the rough matching 413, and the precise matchings 414 and 424 as shown in dashed boxes in the figure, thereby saving the processing time required for these steps. Further, an embodiment of the present disclosure further provides an implementation for further increasing the comparison speed, which will be exemplarily described below in conjunction with FIGS. 5 and 6.

FIG. 5 is a schematic diagram of a fingerprint comparison process including a first screening according to another embodiment of the present disclosure. As shown in FIG. 5, rough alignments 511, 521, 531, and the like in the first-stage fingerprint comparison may be performed on a plurality of enrolled fingerprint images 510, 520, 530, and the like, respectively, and then the first screening may be performed according to the result of each rough alignment to obtain a first screening result (for example, the enrolled fingerprint images 520, 530, and the like in the figure).

Further, in some embodiments, the precise alignment in the second-stage fingerprint comparison and the rough matching in the first-stage fingerprint comparison may be performed on any enrolled fingerprint image in the first screening result and the fingerprint image to be compared, while the enrolled fingerprint image 510 outside of the first screening result is not subjected to any subsequent processing (including a precise alignment 512, a rough matching 513, and a precise matching 514, as shown in the dashed boxes in the diagram). Taking any enrolled fingerprint image 520 in the first screening result as an example, the enrolled fingerprint image 520 and the fingerprint image to be compared may be subjected to a precise alignment 522 and a rough matching 523.

In some embodiments, in response to that the result of the rough matching 523 meets the second preset condition, a precise matching 524 in the second-stage fingerprint comparison may be further performed; and in response to that the result of the rough matching 523 does not meet the second preset condition, the precise matching 524 (shown in a dashed box) may be omitted and instead, a next enrolled fingerprint image 530 in the first screening result is acquired, and a precise alignment 532 and a rough matching 533 are further performed on the result of the rough alignment 531 of the enrolled fingerprint image 530.

In other embodiments, in response to that the result of the rough matching 533 meets the second preset condition, a precise matching 534 in the second-stage fingerprint comparison may be further performed; and in response to that the result of the rough matching 533 does not meet the second preset condition, or in response to that the result of the precise matching 534 does not meet the third preset condition, a next enrolled fingerprint image in the first screening result is acquired for subsequent processing such as a precise alignment, until the comparison is successful, or all enrolled fingerprint images in the first screening result fail to pass the comparison. In still other embodiments, in response to that the result of the precise matching 534 meets the third preset condition, a result may be output, which means that the enrolled fingerprint image 530 corresponding to the precise matching 534 is successfully compared with the fingerprint image to be compared.

In some embodiments, according to a comparison result of results of rough alignments in the first screening result, the enrolled fingerprint images in the first screening result may be further ranked, and subsequent precise alignment and rough matching and the like are firstly performed on the enrolled fingerprint images with better results of rough alignments in the first screening result in sequence. In some embodiments, according to a comparison of similarities and/or voting concentrations of directional features obtained through the rough alignments in the first screening result, the ranking may be performed according to the similarity from high to low and/or the voting concentration from high to low.

Taking the case where the result of the rough alignment 521 in the first screening result is higher than the result of the rough alignment 531, the precise alignment 522 and the rough matching 523 are firstly performed on the enrolled fingerprint image 520 in sequence. In response to that the result of the rough matching 523 does not meet the second preset condition, the precise alignment 532 and the like are then performed on a next enrolled fingerprint image 530 following the enrolled fingerprint image 520, until the comparison is successful, or all enrolled fingerprint images in the first screening result fail to pass the comparison.

According to such ranking, subsequent processing is firstly performed on an enrolled fingerprint image with a higher hit probability in the first screening result, so that the time required for successful comparison is favorably shortened, and the comparison speed, and the comparison precision, are further improved.

While the comparison process according to another embodiment of the present disclosure is exemplarily described above with reference to FIG. 5, it will be understood that the above description is exemplary and not restrictive. For example, the number of enrolled fingerprint images may not be limited to three as shown, and may be provided more or less as needed. For example, it may be not limited to the enrolled fingerprint image 530 successfully compared in the figure, and when the result of the rough matching 523 meets the second preset condition and the result of the further performed precise matching 524 meets the third preset condition, an output result indicating that the enrolled fingerprint image 520 and the fingerprint image to be compared are successfully compared may be determined. It will be further understood that compared with the embodiment shown in FIG. 4, the embodiment shown in FIG. 5 can further improve the comparison speed since not all enrolled fingerprint images in the first screening result are subjected to the precise alignment and the rough matching.

FIG. 6 is a schematic diagram of a fingerprint comparison process according to yet another embodiment of the present disclosure. Compared with the comparison process shown in FIG. 5, the comparison process shown in FIG. 6 may omit the first screening, so that some rough alignments and subsequent processing may be further omitted, and the comparison speed can be further increased. For ease of viewing, each enrolled fingerprint image and a corresponding processing flow of the enrolled fingerprint image are shown in dotted line boxes in the figure. Specifically, as shown in FIG. 6, for a plurality of enrolled fingerprint images 610, 620, 630, and the like, at least one enrolled fingerprint image 610 may be subjected to a rough alignment 611 in the first-stage fingerprint comparison. In response to that the result of the rough alignment 611 does not meet the first preset condition, subsequent processing of the enrolled fingerprint image 610, including a precise alignment 612 (shown in a dashed box), a rough matching 613 (shown in a dashed box), and a precise matching 614 (shown in a dashed box), can be omitted, and a next enrolled fingerprint image 620 is acquired for a rough alignment 621.

In response to that the result of the rough alignment 621 meets the first preset condition, a precise alignment 622 in the second-stage fingerprint comparison and a rough matching 623 in the first-stage fingerprint comparison are further performed. Next, in response to that the result of the rough matching 623 does not meet the second preset condition, a subsequent precise matching 624 (shown in a dashed box) in the second-stage fingerprint comparison may be omitted, and a next enrolled fingerprint image 630 may be acquired. In other embodiments, In response to that the result of the rough alignment 631 between the enrolled fingerprint image 630 and the fingerprint image to be compared meets the first preset condition, a precise alignment 632 and a rough matching 633 are further performed; in response to that the result of the rough matching 633 meets the second preset condition, a precise matching 634 in the second-stage fingerprint comparison is further performed; and in response to that the result of the precise matching 634 meets the third preset condition, it is determined that the enrolled fingerprint image 630 corresponding to the precise matching 634 is successfully compared with the fingerprint image to be compared.

In still other embodiments, in response to that the result of the rough alignment 631 does not meet the first preset condition, or the result of the rough matching 633 does not meet the second preset condition, or the result of the precise matching 634 meets the third preset condition, a next enrolled fingerprint image may be acquired, until the comparison is successful, or all enrolled fingerprint images fail to pass the comparison.

While another specific embodiment of the present disclosure has been exemplarily described above with reference to FIG. 6, it will be understood that compared with the comparison process shown in FIG. 5, the comparison process shown in FIG. 6 may omit the rough alignments of some enrolled fingerprint images, thereby facilitating further increase of the comparison speed.

Through the above description of the technical solutions and embodiments for fingerprint comparison of the present disclosure, it will be understood by those skilled in the art that the method for fingerprint comparison of the present disclosure, by dividing a fingerprint comparison process into a first-stage fingerprint comparison and a second-stage fingerprint comparison, and determining, according to a result of the first-stage fingerprint comparison, whether to perform the second-stage fingerprint comparison, can omit corresponding steps in the second-stage fingerprint comparison if the result of the first-stage fingerprint comparison does not meet certain conditions, so that the computing and comparison time can be saved, and the fingerprint comparison speed can be improved.

In some embodiments, by performing a first screening on the results of rough alignments, enrolled fingerprint images with a lower hit probability can be preliminarily excluded, so that subsequent computation is omitted, which is beneficial to reducing the data processing amount in the whole comparison process and increasing the comparison speed. Further, since a plurality of enrolled fingerprint images are subjected to the first screening, the comparison precision and reliability can be improved.

It will be further understood that the method provided in the embodiments of the disclosure can be applied to not only the comparison requirement of fingerprint images collected by small fingerprint sensors, but also more application scenes as needed, and can be implemented in different embodiments according to the requirements of different application scenes. For example, in some application scenes which require a large data volume as well as a higher precision, such as a criminal investigation fingerprint comparison scene where a defect fingerprint image to be compared, or a fingerprint image to be compared that covers a relatively small fingerprint area, may be collected, the comparison process as shown in FIG. 4 may be adopted, so that the large data volume of the small area fingerprint image can be quickly compared, while all enrolled fingerprint images can be traversed to ensure the precision and reliability of the comparison. In other application scenes which require low-cost comparison of a large data volume, for example, a low-cost access control system, the comparison process shown in FIG. 5 or FIG. 6 may be adopted, so that the low-cost comparison of a large data volume can be implemented, and the user requirements can be met.

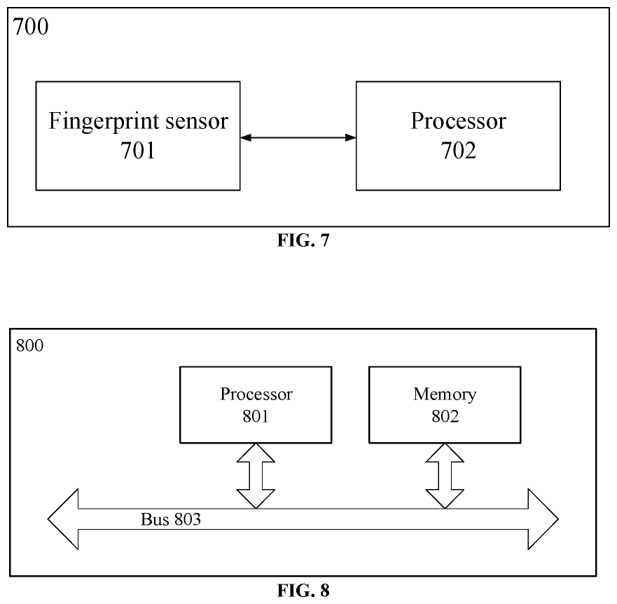

An embodiment of the present disclosure further provides a device for fingerprint comparison, which is exemplarily illustrated below in conjunction with FIG. 7. FIG. 7 is a schematic block diagram of a device for fingerprint comparison according to an embodiment of the present disclosure. As shown in FIG. 7, the device 700 may comprise: a fingerprint sensor 701, which may be configured to collect a fingerprint image to be compared; and a processor 702, which may be configured to: acquire the fingerprint image to be compared; perform a first-stage fingerprint comparison on the fingerprint image to be compared and an enrolled fingerprint image; determine, according to a result of the first-stage fingerprint comparison, whether to perform a second-stage fingerprint comparison on the fingerprint image to be compared and the enrolled fingerprint image; and determine, according to the result of the first-stage fingerprint comparison or a result of the second-stage fingerprint comparison, whether the comparison between the fingerprint image to be compared and the enrolled fingerprint image is successful.

In some embodiments, the first-stage fingerprint comparison may include a rough alignment and/or a rough matching; and the second-stage fingerprint comparison may include at least one of a precise alignment, a rough matching and a precise matching.

In other embodiments, the first-stage fingerprint comparison may include a rough alignment; and the second-stage fingerprint comparison may include a precise alignment.

In still other embodiments, the first-stage fingerprint comparison may further include a rough matching, and while performing the first-stage fingerprint comparison, the processor 702 may be further configured to: perform the rough matching on the enrolled fingerprint image and the fingerprint image to be compared which have been subjected to the precise alignment. The rough matching includes performing a feature matching on one part of feature point pairs in an overlap region between the enrolled fingerprint image and the fingerprint image to be compared, and the feature point pair includes a feature point on the fingerprint image to be compared and a corresponding feature point on the enrolled fingerprint image in the overlap region. The second-stage fingerprint comparison may further include a precise matching, and when determining whether to perform the second-stage fingerprint comparison, the processor 702 may be further configured to: determine, according to a result of the rough matching, whether to perform the precise matching on the enrolled fingerprint image and the fingerprint image to be compared. The precise matching may include performing a feature matching on the other part of feature point pairs in the overlap region. Further, when determining whether the comparison is successful, the processor 702 may be further configured to: determine, according to a result of the precise matching, whether the comparison between the fingerprint image to be compared and the enrolled fingerprint image is successful.

In some embodiments, a plurality of enrolled fingerprint images may be provided, and the processor 702 may be further configured to: acquire a next enrolled fingerprint image, until the comparison is successful or all enrolled fingerprint images fail to pass the comparison, in response to any one of: a result of a current rough alignment failing to meet a first preset condition; a result of a current rough matching failing to meet a second preset condition; and a result of a current precise matching failing to meet a third preset condition.

In other embodiments, a plurality of enrolled fingerprint images may be provided, and the processor 702 may be further configured to: perform a rough alignment on the fingerprint image to be compared and the plurality of enrolled fingerprint images, respectively; and perform a first screening on the plurality of enrolled fingerprint images according to a result of each rough alignment to obtain a first screening result. The first screening result includes enrolled fingerprint images of which the result of the rough alignment meets a first preset condition.

In still other embodiments, the processor 702 may be further configured to: perform a precise alignment and a rough matching on each enrolled fingerprint image in the first screening result and the fingerprint image to be compared; perform, according to a result of the rough matching of each enrolled fingerprint image in the first screening result, a second screening on the first screening result to obtain a second screening result, where the second screening result includes enrolled fingerprint images of which the result of the rough matching meets a second preset condition; perform a precise matching on the other part of feature point pairs corresponding to each enrolled fingerprint image in the second screening result; and determine, according to a result of each precise matching, whether the enrolled fingerprint image in the second screening result is successfully compared with the fingerprint image to be compared.

In some embodiments, the processor 702 may be further configured to: perform a precise alignment and a rough matching on any enrolled fingerprint image in the first screening result and the fingerprint image to be compared; or rank, according to a comparison result of results of rough alignments in the first screening result, the enrolled fingerprint images in the first screening result, and sequentially perform a precise alignment and a rough matching on the enrolled fingerprint images in the first screening result.

In other embodiments, the processor 702 may be further configured to: acquire a next enrolled fingerprint image in the first screening result, until the comparison is successful or all enrolled fingerprint images in the first screening result fail to pass the comparison, in response to at least one of: a result of a current rough matching failing to meet a second preset condition; and a result of a current precise matching failing to meet a third preset condition.

In still other embodiments, the result of the rough alignment may include: a comparison result of directional features of the fingerprint image to be compared and the enrolled fingerprint image after or before the fingerprint image to be compared and/or the enrolled fingerprint image are rotated; and the first preset condition may include at least one of: a similarity of the directional features greater than or equal to a first preset threshold; a voting concentration of the directional features greater than or equal to a second preset threshold; and the like.

In some embodiments, the rough alignment may include a rotational alignment; and the precise alignment may include a displacement alignment.

In other embodiments, the result of the rough matching may include a feature point similarity; and the second preset condition may include: the feature point similarity greater than or equal to a third preset threshold.

In still other embodiments, the result of the precise matching may include a feature point similarity; and the third preset condition may include: the feature point similarity greater than or equal to a fourth preset threshold.

In some embodiments, the one part of feature point pairs may include feature point pairs at peaks, and the other part of feature point pairs may include feature point pairs at valleys; or the one part of feature point pairs and the other part of feature point pairs may be selected in a jump-point mode.

In other embodiments, the fingerprint sensor 701 may have a length and a width both less than or equal to 4 mm.

It will be understood that the device of the present disclosure has been described and explained in detail above in conjunction with the method, which will not be repeated here.

FIG. 8 is a schematic block diagram of an electronic device according to an embodiment of the present disclosure. As shown in FIG. 8, an electronic device 800 may comprise: a processor 801; and a memory 802 that may have program instructions for fingerprint comparison stored thereon which, when executed by the processor 801, cause the electronic device 800 to implement the method as described in conjunction with any one of FIGS. 2 to 6. The processor 801 and the memory 802 may be communicated with each other via a bus 803.

Further, an embodiment of the present disclosure further provides a non-transitory computer-readable storage medium that may have a program for fingerprint comparison stored thereon which, when executed by a processor, causes the method as described in conjunction with any one of FIGS. 2 to 6 to be implemented.

The computer-readable storage medium may be any suitable magnetic or magneto-optical storage medium, such as a resistive random access memory (RRAM), a dynamic random access memory (DRAM), a static random access memory (SRAM), an enhanced dynamic random access memory (EDRAM), a high-bandwidth memory (HBM), a hybrid memory cube (HMC), and the like, or any other medium that can be used to store the desired information and that can be accessed by an application, a module, or both. Any such computer storage medium can be a part of a device, or accessible or connectable to a device. Any application or module described in the present disclosure can be implemented by computer-readable/executable instructions stored on such a computer-readable medium or otherwise maintained.

While various embodiments of the present disclosure have been shown and described herein, it will be obvious to those skilled in the art that such embodiments are provided by way of example only. Numerous modifications, changes, and substitutions may occur to those skilled in the art without departing from the spirit and scope of the present disclosure. It should be understood that various alternatives to the embodiments of the present disclosure described herein may be employed while practicing the present disclosure. It is intended that the following claims define the scope of the present disclosure and that equivalents or alternatives within the scope of these claims are covered thereby.

What is claimed is:

1. A method for fingerprint comparison, the method comprising:
acquiring a fingerprint image to be compared;
performing a first-stage fingerprint comparison on the fingerprint image to be compared and an enrolled fingerprint image;
determining, according to a result of the first-stage fingerprint comparison, whether to perform a second-stage fingerprint comparison on the fingerprint image to be compared and the enrolled fingerprint image; and
determining, according to the result of the first-stage fingerprint comparison or a result of the second-stage fingerprint comparison, whether the comparison between the fingerprint image to be compared and the enrolled fingerprint image is successful.

2. The method of claim 1, wherein the first-stage fingerprint comparison includes a rough alignment and/or a rough matching; and
the second-stage fingerprint comparison includes at least one of a precise alignment, a rough matching and a precise matching.

3. The method of claim 2, wherein the first-stage fingerprint comparison includes a rough alignment; and
the second-stage fingerprint comparison includes a precise alignment.

4. The method of claim 3, wherein the first-stage fingerprint comparison further includes a rough matching; and
the performing of the first-stage fingerprint comparison further comprises performing the rough matching on the enrolled fingerprint image and the fingerprint image to be compared which have been subjected to the precise alignment, wherein the rough matching includes performing a feature matching on one part of feature point pairs in an overlap region between the enrolled fingerprint image and the fingerprint image to be compared, and the feature point pair includes a feature point on the fingerprint image to be compared and a corresponding feature point on the enrolled fingerprint image in the overlap region;
the second-stage fingerprint comparison further includes a precise matching;
the determining whether to perform the second-stage fingerprint comparison further comprises determining, according to a result of the rough matching, whether to perform the precise matching on the enrolled fingerprint image and the fingerprint image to be compared, wherein the precise matching includes performing a feature matching on the other part of feature point pairs in the overlap region; and
the determining whether the comparison is successful comprises determining, according to a result of the precise matching, whether the comparison between the fingerprint image to be compared and the enrolled fingerprint image is successful.

5. The method of claim 4, wherein a plurality of enrolled fingerprint images are provided, and the method further comprises:
acquiring a next enrolled fingerprint image, until the comparison is successful or all enrolled fingerprint images fail to pass the comparison, in response to any one of:
a result of a current rough alignment failing to meet a first preset condition;
a result of a current rough matching failing to meet a second preset condition; and
a result of a current precise matching failing to meet a third preset condition.

6. The method of claim 4, wherein a plurality of enrolled fingerprint images are provided, and the method further comprises:
performing a rough alignment on the fingerprint image to be compared and the plurality of enrolled fingerprint images, respectively; and
performing a first screening on the plurality of enrolled fingerprint images according to a result of each rough alignment to obtain a first screening result, wherein the first screening result includes enrolled fingerprint images of which the result of the rough alignment meets a first preset condition.

7. The method of claim 6, further comprising:
performing a precise alignment and a rough matching on each enrolled fingerprint image in the first screening result and the fingerprint image to be compared;
performing, according to a result of the rough matching of each enrolled fingerprint image in the first screening result, a second screening on the first screening result to obtain a second screening result, wherein the second screening result includes enrolled fingerprint images of which the result of the rough matching meets a second preset condition;
performing a precise matching on the other part of feature point pairs corresponding to each enrolled fingerprint image in the second screening result; and
determining, according to a result of each precise matching, whether the enrolled fingerprint image in the second screening result is successfully compared with the fingerprint image to be compared.

8. The method of claim 6, further comprising:
performing a precise alignment and a rough matching on any enrolled fingerprint image in the first screening result and the fingerprint image to be compared; and/or
ranking, according to a comparison result of results of rough alignments in the first screening result, the enrolled fingerprint images in the first screening result, and sequentially performing a precise alignment and a rough matching on the enrolled fingerprint images in the first screening result.

9. The method of claim 8, further comprising:
acquiring a next enrolled fingerprint image in the first screening result, until the comparison is successful or all enrolled fingerprint images in the first screening result fail to pass the comparison, in response to at least one of:
a result of a current rough matching failing to meet a second preset condition; and
a result of a current precise matching failing to meet a third preset condition.

10. The method of claim 5, wherein the result of the rough alignment includes:
a comparison result of directional features of the fingerprint image to be compared and the enrolled fingerprint image after or before the fingerprint image to be compared and/or the enrolled fingerprint image are rotated; and
the first preset condition includes at least one of:
a similarity of the directional features greater than or equal to a first preset threshold; and
a voting concentration of the directional features greater than or equal to a second preset threshold.

11. The method of claim 2, wherein the rough alignment includes a rotational alignment; and
the precise alignment includes a displacement alignment.

12. The method of claim 5, wherein the result of the rough matching includes a feature point similarity; and
the second preset condition includes the feature point similarity greater than or equal to a third preset threshold.

13. The method of claim 5, wherein the result of the precise matching includes a feature point similarity; and
the third preset condition includes the feature point similarity greater than or equal to a fourth preset threshold.

14. The method of claim 4, wherein the one part of feature point pairs include feature point pairs at peaks, and the other part of feature point pairs include feature point pairs at valleys; or
the one part of feature point pairs and the other part of feature point pairs are selected in a jump-point mode.

15. The method of claim 1, wherein the fingerprint image to be compared is collected by a fingerprint sensor with a length and a width both less than or equal to 4 mm.

16. A device for fingerprint comparison, comprising:
a fingerprint sensor configured to collect a fingerprint image to be compared; and
a processor configured to:
acquire the fingerprint image to be compared;
perform a first-stage fingerprint comparison on the fingerprint image to be compared and an enrolled fingerprint image;
determine, according to a result of the first-stage fingerprint comparison, whether to perform a second-stage fingerprint comparison on the fingerprint image to be compared and the enrolled fingerprint image; and
determine, according to the result of the first-stage fingerprint comparison or a result of the second-stage fingerprint comparison, whether the comparison between the fingerprint image to be compared and the enrolled fingerprint image is successful.

17. The device of claim 16, wherein the first-stage fingerprint comparison includes a rough alignment and/or a rough matching; and
the second-stage fingerprint comparison includes at least one of a precise alignment, a rough matching and a precise matching.

18. The device of claim 17, wherein the first-stage fingerprint comparison includes a rough alignment; and
the second-stage fingerprint comparison includes a precise alignment.

19. The device of claim 18, wherein the first-stage fingerprint comparison further includes a rough matching, and while performing the first-stage fingerprint comparison, the processor is further configured to:
perform the rough matching on the enrolled fingerprint image and the fingerprint image to be compared which have been subjected to the precise alignment, wherein the rough matching includes performing a feature matching on one part of feature point pairs in an overlap region between the enrolled fingerprint image and the fingerprint image to be compared, and the feature point pair includes a feature point on the fingerprint image to be compared and a corresponding feature point on the enrolled fingerprint image in the overlap region;
the second-stage fingerprint comparison further includes a precise matching, and when determining whether to perform the second-stage fingerprint comparison;
the processor is further configured to:
determine, according to a result of the rough matching, whether to perform the precise matching on the enrolled fingerprint image and the fingerprint image to be compared, wherein the precise matching includes performing a feature matching on the other part of feature point pairs in the overlap region; and
when determining whether the comparison is successful, the processor is further configured to:
determine, according to a result of the precise matching, whether the comparison between the fingerprint image to be compared and the enrolled fingerprint image is successful.

20. The device of claim 19, wherein a plurality of enrolled fingerprint images are provided, and the processor is further configured to:
acquire a next enrolled fingerprint image, until the comparison is successful or all enrolled fingerprint images fail to pass the comparison, in response to any one of:
a result of a current rough alignment failing to meet a first preset condition;
a result of a current rough matching failing to meet a second preset condition; and
a result of a current precise matching failing to meet a third preset condition.

21. The device of claim 19, wherein a plurality of enrolled fingerprint images are provided, and the processor is further configured to:
perform a rough alignment on the fingerprint image to be compared and the plurality of enrolled fingerprint images, respectively; and
perform a first screening on the plurality of enrolled fingerprint images according to a result of each rough alignment to obtain a first screening result, wherein the first screening result includes enrolled fingerprint images of which the result of the rough alignment meets a first preset condition.

22. The device of claim 21, wherein the processor is further configured to:
perform a precise alignment and a rough matching on each enrolled fingerprint image in the first screening result and the fingerprint image to be compared;
perform, according to a result of the rough matching of each enrolled fingerprint image in the first screening result, a second screening on the first screening result to obtain a second screening result, wherein the second screening result includes enrolled fingerprint images of which the result of the rough matching meets a second preset condition;
perform a precise matching on the other part of feature point pairs corresponding to each enrolled fingerprint image in the second screening result; and
determine, according to a result of each precise matching, whether the enrolled fingerprint image in the second screening result is successfully compared with the fingerprint image to be compared.

23. The device of claim 21, wherein the processor is further configured to:
perform a precise alignment and a rough matching on any enrolled fingerprint image in the first screening result and the fingerprint image to be compared; and/or
rank, according to a comparison result of results of rough alignments in the first screening result, the enrolled fingerprint images in the first screening result, and sequentially perform a precise alignment and a rough matching on the enrolled fingerprint images in the first screening result.

24. The device of claim 23, wherein the processor is further configured to:
acquire a next enrolled fingerprint image in the first screening result, until the comparison is successful or all enrolled fingerprint images in the first screening result fail to pass the comparison, in response to at least one of:
a result of a current rough matching failing to meet a second preset condition; and
a result of a current precise matching failing to meet a third preset condition.

25. The device of claim 20, wherein the result of the rough alignment includes: a comparison result of directional features of the fingerprint image to be compared and the enrolled fingerprint image after or before the fingerprint image to be compared and/or the enrolled fingerprint image are rotated; and
the first preset condition includes at least one of:
a similarity of the directional features greater than or equal to a first preset threshold; and
a voting concentration of the directional features greater than or equal to a second preset threshold.

26. The device of claim 17, wherein the rough alignment includes a rotational alignment; and
the precise alignment includes a displacement alignment.

27. The device of claim 20, wherein the result of the rough matching includes a feature point similarity; and
the second preset condition includes the feature point similarity greater than or equal to a third preset threshold.

28. The device of claim 20, wherein the result of the precise matching includes a feature point similarity; and
the third preset condition includes the feature point similarity greater than or equal to a fourth preset threshold.

29. The device of claim 19, wherein the one part of feature point pairs include feature point pairs at peaks, and the other part of feature point pairs include feature point pairs at valleys; or
the one part of feature point pairs and the other part of feature point pairs are selected in a jump-point mode.
